(19) United States
(12) Patent Application Publication
(10) Pub. No.: US 2015/0032668 A1
(43) Pub. Date: Jan. 29, 2015

(54) INFORMATION PROCESSING APPARATUS, INFORMATION PROCESSING METHOD, PROGRAM, AND INFORMATION PROCESSING SYSTEM

(71) Applicant: Sony Corporation, Tokyo (JP)

(72) Inventors: Naoya SAZUKA, Tokyo (JP); Shinako MATSUYAMA, Tokyo (JP); Jingjing GUO, Tokyo (JP); Jin PAN, Tokyo (JP)

(21) Appl. No.: 14/300,522

(22) Filed: Jun. 10, 2014

(30) Foreign Application Priority Data
Jul. 26, 2013 (JP) 2013-155789

(51) Int. Cl. G06N 5/02

(52) U.S. Cl. CPC G06N 5/02
USPC 706/11

(57) ABSTRACT

There is provided an information processing apparatus including a processor which executes a function of acquiring activity information indicating at least an activity of a subject, the activity information being inputted by an inputter, a function of generating support information supporting the activity of the subject on the basis of the activity information, and a function of controlling an output of the support information to the inputter or an observer who is different from the subject and the inputter on the basis of the support information or the activity information.

### CROSS REFERENCE TO RELATED APPLICATIONS

This application claims the benefit of Japanese Priority Patent Application JP 2013-155789 filed Jul. 26, 2013, the entire contents of which are incorporated herein by reference.

### BACKGROUND

The present disclosure relates to an information processing apparatus, an information processing method, a program, and an information processing system.

A large number of techniques have been proposed already for watching a subject who needs nursing or care, such as a toddler or an elderly person. For example, JP 2002-149909A discloses a system that uses a camera imaging a toddler and a monitoring apparatus including a sensor that detects the state of the toddler, sends regularly image information and sensor information to a management server so that a guardian can view the information, and sends a report to an observer when the monitoring apparatus detects an abnormal state.

### SUMMARY

With the techniques such as that disclosed in JP 2002-149909A, however, it has not been easy for the system to determine the state of the subject accurately from information that is automatically detected by the camera or the sensor. Accordingly, information is outputted by an active report (automatic output) from the system only when the abnormal state is obvious: in other cases, the guardian, a caregiver, and the like had had to access information accumulated in the management server.

Although the information accumulated in the management server includes useful information for nursing or care, the amount of the information is so large that it has not been easy to find the useful information. Further, a busy guardian or caregiver sometimes might not find the accumulated information. On the other hand, if all the acquired information is automatically outputted in real time, information, whether important or not, will be transmitted constantly to the guardian or the caregiver, and no attention will be paid to the information itself in the end.

Accordingly, the present disclosure proposes a novel and improved information processing apparatus, information processing method, program, and information processing system which enable provision of appropriate information at an appropriate time by use of inputted information related to a subject.

According to an embodiment of the present disclosure, there is provided an information processing apparatus including a processor which executes a function of acquiring activity information indicating at least an activity of a subject, the activity information being inputted by an inputter, a function of generating support information supporting the activity of the subject on the basis of the activity information, and a function of controlling an output of the support information to the inputter or an observer who is different from the subject and the inputter on the basis of the support information or the activity information.

According to another embodiment of the present disclosure, there is provided an information processing method performed by a processor of a computer, the information processing method including acquiring activity information indicating at least an activity of a subject, the activity information being inputted by an inputter, generating support information supporting the activity of the subject on the basis of the activity information, and controlling an output of the support information to the inputter or an observer who is different from the subject and the inputter on the basis of the support information or the activity information.

According to another embodiment of the present disclosure, there is provided a program for causing a processor of a computer to execute a function of acquiring activity information indicating at least an activity of a subject, the activity information being inputted by an inputter, a function of generating support information supporting the activity of the subject on the basis of the activity information, and a function of controlling an output of the support information to the inputter or an observer who is different from the subject and the inputter on the basis of the support information or the activity information.

According to another embodiment of the present disclosure, there is provided an information processing system including one or more information processing apparatuses which execute a function of generating activity information indicating an activity of a subject according to an input operation made by an inputter, a function of generating support information supporting the activity of the subject on the basis of the activity information, a function of controlling an output of the support information to the inputter or an observer who is different from the subject and the inputter on the basis of the support information or the activity information, and a function of outputting the support information to the inputter or the observer.

As described above, according to one or more of embodiments of the present disclosure, it is possible to provide appropriate information at an appropriate time by use of inputted information related to a subject.

### BRIEF DESCRIPTION OF THE DRAWINGS

FIG. 1 shows a schematic configuration of an information processing system according to an embodiment of the present disclosure;

FIG. 2 is a block diagram showing a schematic hardware configuration of an information processing apparatus that achieves an input terminal and an output terminal according to an embodiment of the present disclosure;

FIG. 3 is a block diagram showing a schematic hardware configuration of an information processing apparatus achieving a server apparatus according to an embodiment of the present disclosure;

FIG. 4 is a block diagram showing a schematic function configuration achieved by a server according to an embodiment of the present disclosure;

FIG. 5 shows an example of inputting activity information of a subject by use of an NFC in an embodiment of the present disclosure;

FIG. 6 shows a first example of summary-type support information in an embodiment of the present disclosure;

FIG. 7 shows a second example of summary-type support information in an embodiment of the present disclosure;

FIG. 8 shows a third example of summary-type support information in an embodiment of the present disclosure;

FIG. 9 shows a fourth example of summary-type support information in an embodiment of the present disclosure;

FIG. 10 shows a fifth example of summary-type support information in an embodiment of the present disclosure;

FIG. 11 shows a sixth example of summary-type support information in an embodiment of the present disclosure;

FIG. 12 shows a first example of advice-type support information in an embodiment of the present disclosure;

FIG. 13A shows a second example of advice-type support information in an embodiment of the present disclosure;

FIG. 13B shows a second example of advice-type support information in an embodiment of the present disclosure;

FIG. 14 shows a third example of advice-type support information in an embodiment of the present disclosure: and

FIG. 15 shows a fourth example of advice-type support information in an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be made in the following order.

1. System configuration
1-1. Overview configuration
1-2. Hardware configuration
1-3. Function configuration

2. Examples of input of activity information

3. Examples of summary-type support information

4. Examples of advice-type support information

5. Examples of sharing support information

6. Examples of output control of support information

7. Supplement

(1. System configuration)

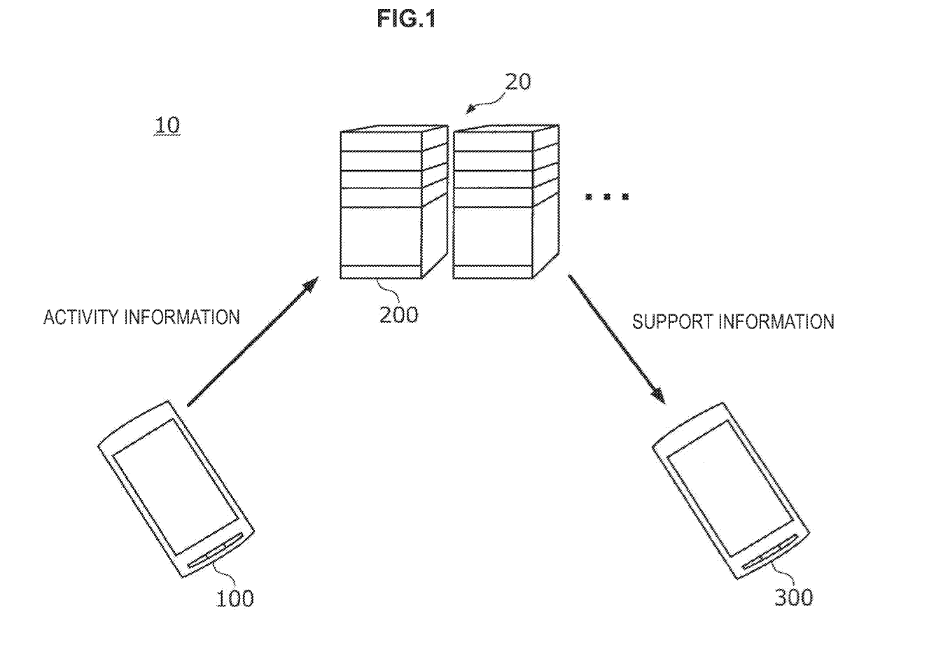

First, a configuration of an information processing system according to an embodiment of the present disclosure will be described with reference to FIGS. 1 to 4.

### (1-1. Overview Configuration)

FIG. 1 shows a schematic configuration of the information processing system according to an embodiment of the present disclosure. Referring to FIG. 1, an information processing system 10 includes an input terminal 100, a server 20, and an output terminal 300. The server 20 includes one or more server apparatuses 200. The input terminal 100, the server 20, and the output terminal 300 communicate with one another via a network. Note that although being illustrated as separate terminal apparatuses, the input terminal 100 and the output terminal 300 may be achieved by being integrated by a terminal apparatus such as a smartphone, as will be described later.

The input terminal 100 generates activity information indicating an activity of a subject according to an input operation made by an inputter. Although the details will be described later, the input terminal 100 includes a near field communication (NFC) reader for example, and generates activity information through communication with an NFC tag disposed on a tool used for the activity of the subject. Alternatively, the input terminal 100 may include a reader of a two-dimensional code, such as a camera module, and generate activity information through reading of a two-dimensional code disposed on a tool used for the activity of the subject. The generated activity information is transmitted to the server 20.

The server 20 receives the activity information from the input terminal 100 and generates support information which supports the activity of the subject on the basis of the activity information. The generated support information is transmitted to the output terminal 300. Here, on the basis of the generated support information and/or the activity information used to generate the support information, the server 20 controls an output of the support information in the output terminal 300. Note that although an example in which the server 20 includes the single server apparatus 200 will be described below, the server 20 may include the plurality of server apparatuses 200 as described above, in which case functions of the server 20 can be dispersed to the plurality of server apparatuses 200 to be achieved.

The output terminal 300 outputs the support information received from the server 20. Here, the output terminal 300 may be held by a user of the input terminal 100, that is, the inputter, for example. Alternatively, the output terminal 300 may be held by a user who is different from the user of the input terminal 100, that is, an observer who is different from the subject and the inputter. The output terminal 300 outputs the support information by displaying the support information on a display, for example. In a case where the inputter holds the output terminal 300, by use of a smartphone including a display, an NFC reader, and a reader of a two-dimensional code, the input terminal 100 and the output terminal 300 can be achieved by being integrated.

### (1-2. Hardware Configuration)

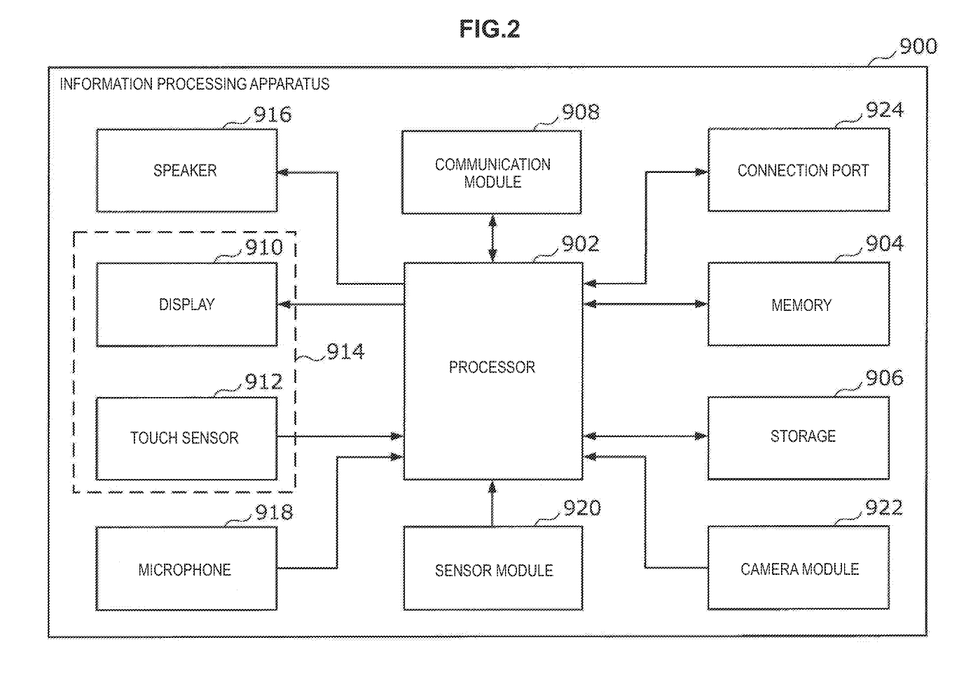

FIG. 2 is a block diagram showing a schematic hardware configuration of an information processing apparatus that achieves an input terminal and an output terminal according to an embodiment of the present disclosure. Referring to FIG. 2, an information processing apparatus 900 can include a processor 902, a memory 904, a storage 906, a communication module 908, a touch panel 914 including a display 910 and a touch sensor 912, a speaker 916, a microphone 918, a sensor module 920, a camera module 922, and a connection port 924.

The processor 902 is achieved by a central processing unit (CPU), a digital signal processor (DSP), an application specific integrated circuit (ASIC), or the like, and achieves various functions by operating in accordance with a program stored in the memory 904. The processor 902 controls each part of the information processing apparatus 900, thereby acquiring various inputs and providing various outputs. Note that details of functions achieved by the processor 902 will be described later.

Here, in this embodiment, in the information processing apparatus 900 which achieves at least the input terminal 100, the processor 902 transmits information, generated on the basis of an input acquired by each part of the information processing apparatus 900, to the server 20 via the communication module 908, as activity information indicating an activity of the subject. Note that a specific example of the input acquired by the information processing apparatus 900 to generate the activity information will be shown in the description of each structural element below.

The memory 904 is achieved by a semiconductor memory used as random access memory (RAM) or read only memory (ROM), for example. The memory 904 stores a program by which the processor 902 operates, for example. This program may be read out from the storage 906 and developed temporarily to the memory 904, or may be stored persistently in the memory 904. Alternatively, the program may be received by the communication module 908 and developed temporarily to the memory 904. The memory 904 further stores various data generated by processes of the processor 902 temporarily or persistently.

The storage 906 is achieved by a memory device using a magnetic disk such as a hard disk drive (HDD), an optical disk, a magneto-optical disk, or the like, or a flash memory, for example. The storage 906 persistently stores a program by which the processor 902 operates and various data generated by processes of the processor 902, for example. The storage 906 may include a removable medium or may be incorporated in the information processing apparatus 900.

The communication module 908 is achieved by various communication circuits that execute a network communication with or without wires under control of the processor 902. In a case of a wireless communication, the communication module 908 may include an antenna. The communication module 908 executes a network communication compliant with a communication standard such as the Internet, local area network (LAN), or Bluetooth (registered trademark). The communication module 908 can transmit the information generated in the information processing apparatus 900 to the server 20, another information processing apparatus 900, or the like, and can also receive various pieces of information from the server 20 or the other information processing apparatus 900.

Here, in this embodiment, in the information processing apparatus 900 which achieves at least the input terminal 100, the communication module 908 may include an antenna and a communication circuit functioning as an NFC reader. In such a case, the communication module 908 communicates with an NFC tag disposed on a tool used for an activity of the subject, and provides information acquired through the communication to the processor 902.

The display 910 is achieved by a liquid crystal display (LCD), an organic electroluminescence (EL) display, or the like. The display 910 displays various pieces of information as images under control of the processor 902. In the shown example, since the touch panel 914 including the display 910 and the touch sensor 912 is used as an input means, the display 910 can display a graphical user interface (GUI) image that is operable with the touch sensor 912.

The touch sensor 912 is achieved by a capacitive sensor provided at a position corresponding to the display 910, for example. The touch sensor 912 acquires a touch operation made by a user on the GUI image displayed on the display 910. Note that in other embodiments, in addition to or instead of the touch sensor 912, a pointing device such as a mouse or a touch pad, or other input devices such as a keyboard or a button may be employed.

Here, in this embodiment, in the information processing apparatus 900 which achieves at least the input terminal 100, an input operation of the activity information made by the inputter may be accepted by use of the touch panel 914 including the display 910 and the touch sensor 912. The input operation may be a text input or an input using a GUI.

Further, in this embodiment, in the information processing apparatus 900 which achieves at least the output terminal 300, the display 910 displays support information received from the server 20. The observer or the inputter who views the support information displayed on the display 910 can further view other support information and the activity information from which the support information is generated, by an operation input given to the touch panel 914. In a case where the support information or a report of a reception of the support information is automatically displayed on the display 910 without an operation of a user via the touch panel 914 for example, the support information can be regarded as being automatically inputted to the observer or the inputter who holds the output terminal 300.

The speaker 916 outputs various pieces of information as a voice under control of the processor 902. The microphone 918 acquires various kinds of voices around the information processing apparatus 900, such as the user's spoken voice, and provides the voices as voice data to the processor 902.

Here, in this embodiment, in the information processing apparatus 900 which achieves at least the output terminal 300, the support information generated in the server 20 can be outputted as a voice from the speaker 916. Alternatively, the speaker 916 may output a report of a reception of the support information as a voice. Note that the report of the reception of the support information may be outputted as vibration by a vibrator (not shown) provided in the information processing apparatus 900 which achieves the output terminal 300. By use of an output device other than the display 910, such as the speaker 916, the support information and/or the report of the reception of the support information can be automatically outputted. Further, in this embodiment, in the information processing apparatus 900 which achieves at least the input terminal 100, the microphone 918 may be used for an input of activity information by a spoken voice of the inputter.

The sensor module 920 is achieved by various sensors such as an acceleration sensor, a gyro sensor, a geomagnetism sensor, a photo sensor, an air pressure sensor, and a sound sensor, and a process circuit accompanying the sensor. The sensor module 920 may acquire information regarding the state of the information processing apparatus 900 itself, such as the acceleration working on a housing of the information processing apparatus 900 or the direction of the housing, and in addition, may acquire information regarding an ambient environment of the information processing apparatus 900, such as the brightness or noise around the information processing apparatus 900. Further, the sensor module 920 may include a global positioning system (GPS) sensor that measures the latitude, longitude, and altitude of the information processing apparatus 900 by receiving a GPS signal.

Here, in this embodiment, in the information processing apparatus 900 which achieves at least the output terminal 300, information acquired automatically by the sensor module 920 can be transmitted to the server 20 via the processor 902 and the communication module 908 as other activity information indicating an activity of the observer or the inputter. As will be described later, the transmitted activity information related to the observer or the inputter can be analyzed in the server 20 by a technique of human behavior recognition.

The camera module 922 is achieved by an image sensor such as a charge coupled device (CCD) or a complementary metal oxide semiconductor (CMOS), an optical system such as a lens for controlling formation of an image of an object in the image sensor, and a driver circuit that causes the image sensor and the optical system to drive. The camera module 922 provides a still image or a moving image generated by the image sensor imaging the object to the processor 902 as image data.

Here, in this embodiment, in the information processing apparatus 900 which achieves at least the input terminal 100, the camera module 922 may be used as a reader of a two-dimensional code. In this case, the camera module 922 provides image data including a two-dimensional code disposed on a tool used for an activity of the subject to the processor 902.

The connection port 924 is a port for connecting an external apparatus directly to the information processing apparatus 900, and is achieved by a universal serial bus (USB) port, an IEEE1394 port, a high-definition multimedia interface (HDMI) port, or the like. Examples of the external apparatus connected to the connection port 924 include, but are not limited to, a display device (e.g., external display), an input device (e.g., keyboard or mouse), and a memory device (e.g., external HDD).

The information processing apparatus 900 including the above-described structural elements can be a smartphone, a tablet terminal, any personal computer (PC), or the like. Further, the information processing apparatus 900 may be a media player, a game machine, a television, or the like. The kind of the information processing apparatus 900 achieving the input terminal 100 and/or the output terminal 300 can be determined as appropriate according to an input method of the activity information (whether an NFC or a two-dimensional code is used, whether a text input or a GUI input is used, or whether a voice input is used), the frequency of reference to the support information (whether the support information is referred to at any time when going out or collectively at home), or the like.

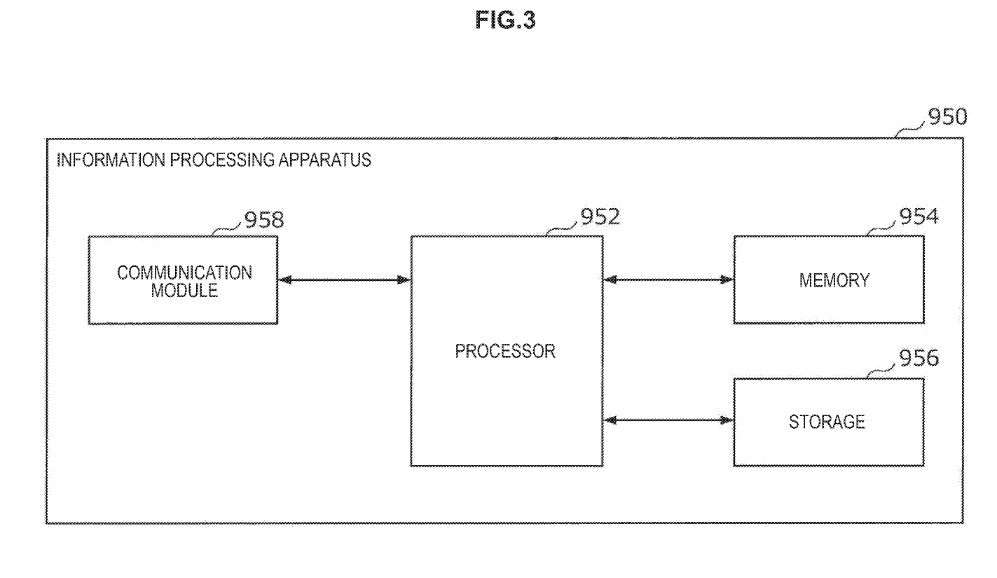

FIG. 3 is a block diagram showing a schematic hardware configuration of an information processing apparatus achieving a server apparatus according to an embodiment of the present disclosure. Referring to FIG. 3, an information processing apparatus 950 can include a processor 952, a memory 954, a storage 956, and a communication module 958.

Note that the following description will be made by regarding the information processing apparatus 950 which achieves the server apparatus 200 as an apparatus that is installed mainly for providing a service to the input terminal 100 and the output terminal 300 on a network and that does not perform an information output to a user or acquire an operation input by itself other than a case of a setting operation. However, the server apparatus 200 is not limited to such an information processing apparatus 950 and may be achieved by an information processing apparatus having the same configuration as the information processing apparatus 900 which achieves the input terminal 100 and/or the output terminal 300, for example. That is, for example, a smartphone carried by a user can achieve the input terminal 100 and the output terminal 300 and a desk top PC of the user installed at home can achieve the server apparatus 200.

The processor 952 is achieved by a CPU, a DSP, an ASIC, or the like, and achieves various functions by operating in accordance with a program stored in the memory 954. The processor 952 receives, via the communication module 958, information such as activity information transmitted from the input terminal 100 and/or the output terminal 300 via the communication module 958, and executes various processes on the basis of this information. The processor 952 transmits information on a process result such as support information to the output terminal 300 via the communication module 958, for example. The server apparatus 200 can provide a service to a plurality of the input terminals 100 and the output terminals 300. Accordingly, the processor 952 may execute, in parallel or consequently, a process of transmitting information on a process result based on information received from one of the input terminals 100 to one of the output terminals 300 and a process of transmitting information on a process result based on information received from another input terminal 100 to another output terminal 300.

Here, in this embodiment, the processor 952 generates support information on the basis of activity information received from the input terminal 100. Here, the processor 952 may generate the support information on the basis of the received activity information only or may generate the support information on the basis of the received activity information in combination with activity information which is already accumulated in the storage 956. In a case of generating the support information on the basis of the received activity information, the processor 952 can generate the support information in real time. Alternatively, the processor 952 may generate the support information on the basis of the activity information only, which is accumulated in the storage 956. Further, the processor 952 controls an output of the generated support information to the output terminal 300 via the communication module 958, thereby controlling an output of the support information to the user in the output terminal 300. Note that details of functions that can be achieved by the processor 952 will be described later.

The memory 954 is achieved by a semiconductor memory used as RAM or ROM, for example. The memory 954 stores a program by which the processor 952 operates, for example. This program may be read out from the storage 956 and developed temporarily to the memory 954, or may be stored persistently in the memory 954. Alternatively, the program may be received by the communication module 958 and developed temporarily to the memory 954. The memory 954 further stores, temporarily or persistently, various data to be referred to in processes of the processor 952 and various data generated by processes of the processor 952.

The storage 956 is achieved by a memory device using a magnetic disk such as an HDD, an optical disk, a magneto-optical disk, or the like, or a flash memory, for example. The storage 956 persistently stores a program by which the processor 952 operates and various data generated by processes of the processor 952, for example. The storage 956 may include a removable medium or may be incorporated in the information processing apparatus 950.

Here, in this embodiment, the storage 956 accumulates activity information received from the input terminal 100, for example. The accumulated activity information can be read out as necessary by the processor 952 and be used to generate support information. The support information generated by the processor 952 can also be stored in the storage 956. Further, the storage 956 can store knowledge information related to an activity of the subject. In this case, the processor 952 refers to the knowledge information stored in the storage 956 as necessary and generates the support information on the basis of activity information of the subject. Alternatively, it is possible to use, as the knowledge information, in addition to or instead of the information stored in the storage 956, information acquired at any time from another server or the like on the network via the communication module 958. Note that specific examples of the knowledge information will be shown later.

The communication module 958 is achieved by various communication circuits that execute a network communication with or without wires under control of the processor 952. In a case of a wireless communication, the communication module 958 may include an antenna. The communication module 958 executes a network communication compliant with a communication standard such as the Internet or LAN. The communication module 958 can receive various pieces of information from the input terminal 100 and/or the output terminal 300 and can transmit the information generated in the server apparatus 200 to the output terminal 300. In a case where the server 20 is achieved by cooperation of the plurality of server apparatuses 200, processors 952 of information processing apparatuses 950 achieving the respective server apparatuses 200 exchange information related to processes via the communication module 958.

### (1-3. Function Configuration)

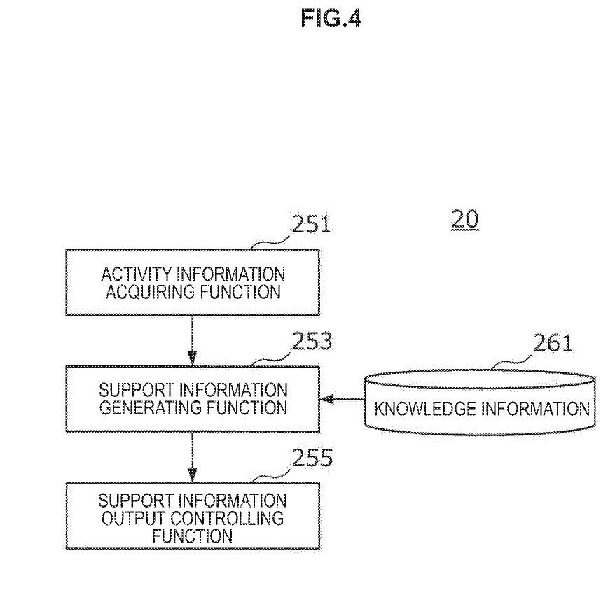

FIG. 4 is a block diagram showing a schematic function configuration achieved by a server according to an embodiment of the present disclosure. Referring to FIG. 4, in this embodiment, the server 20 achieves an activity information acquiring function 251, a support information generating function 253, and a support information output controlling function 255. These functions are achieved by processor(s) (e.g., the above-described processor 952 of the information processing apparatus 950) of the single or plurality of server apparatuses 200 included in the server 20, for example.

The activity information acquiring function 251 acquires activity information indicating an activity of the subject, the activity information being transmitted from the input terminal 100 (hereinafter also simply referred to as activity information of a subject). Here, the activity information of the subject is inputted by the inputter in the input terminal 100. For example, the activity information of the subject is generated in the input terminal 100 on the basis of information acquired by an NFC reader communicating with an NFC tag disposed on a tool used for an activity of the subject. Further, for example, the activity information of the subject may be generated in the input terminal 100 on the basis of information acquired by a camera module as a reader of a two-dimensional code reading a two-dimensional code disposed on a tool used for an activity of the subject. Furthermore, for example, the activity information of the subject may be generated in the input terminal 100 on the basis of information inputted through an operation made by the inputter, such as a text input or a GUI input.

Further, the activity information acquiring function 251 may acquire, in addition to the activity information indicating the activity of the subject, activity information indicating an activity of the inputter or the observer (hereinafter also simply referred to as activity information of the inputter or the observer). The activity information of the inputter or the observer can include, in the output terminal 300 (as described above, the output terminal 300 can be the same terminal apparatus as the input terminal 100), information acquired automatically by a sensor module. Alternatively, the activity information of the inputter or the observer may include, in the output terminal 300, information that is expressly inputted by the inputter or the observer. Further, as for the inputter, the activity information indicating the activity of the subject (inputted by the inputter) can also be used as the activity information indicating the activity of the inputter.

The support information generating function 253 generates support information that supports the activity of the subject on the basis of the activity information acquired by the activity information acquiring function 251. The activity information used here includes at least the activity information of the subject, and may use additionally the activity information of the inputter or the observer. The support information may be any information as long as the information supports directly or indirectly the activity of the subject. For example, the support information may be information that is generated purely on the basis of the activity information of the subject and that indicates whether or not the activity of the subject is statistically normal (whether or not the activity of the subject is within an average range indicated by the activity information of the same subject acquired in a predetermined period).

Further, the support information may be generated on the basis of knowledge information 261 related to the activity of the subject, the knowledge information 261 being stored in the storage (the above-described storage 956 of the information processing apparatus 950) of the server apparatus 200, for example. The knowledge information 261 can be information that is generated on the basis of a technical knowledge and/or statistical data related to the activity of the subject, for example. For example, the support information generated on the basis of the knowledge information 261 can reveal the meaning of the activity of the subject. Further, for example, the support information generated on the basis of the knowledge information 261 may indicate the necessity of improvement of the activity of the subject.

Here, the support information generating function 253 can generate the support information in real time when the activity information acquiring function 251 acquires the activity information. Note that it is not necessary that the support information generating function 253 generates the support information on the basis of all the activity information acquired by the activity information acquiring function 251. That is, for example, even in a case where the activity information acquiring function 251 acquires the activity information of the subject, when the support information generating function 253 determines that it is unnecessary to generate the support information on the basis of the activity information, the activity information is not necessarily used to generate the support information. Note that, even in this case, however, the activity information can be accumulated in the server 20 as statistical data for the support information that will be generated later, for example.

The support information output controlling function 255 controls an output of the support information to the output terminal 300 on the basis of at least any one of the support information generated by the support information generating function 253 and the activity information acquired by the activity information acquiring function 251 (the activity information may be the activity information of the subject or the activity information of the inputter or the observer). Here, since the output terminal 300 is held by the observer or the inputter and the support information outputted from the output terminal 300 is viewed by the observer or the inputter (in a case where the support information is displayed on a display), for example, the support information output controlling function 255 can also be said to control the output of the support information to the observer or the inputter.

For example, the support information output controlling function 255 may output automatically the support information from the output terminal 300 according to the content of the support information and/or the activity information. In this case, for example, when the support information is generated, the support information output controlling function 255 can determine whether or not the support information is outputted automatically from the output terminal 300 in real time. More specifically, for example, in a case where the support information output controlling function 255 determines that certain support information is not to be outputted automatically, that support information is accumulated in the server 20. Subsequently, when other support information is determined to be outputted automatically or the automatic output is determined to be possible under other conditions, the support information output controlling function 255 may output the accumulated support information from the output terminal 300. Further, for example, in a case where the support information output controlling function 255 determines that certain support information is not to be outputted automatically, that support information may be accumulated in the server 20 so that the support information can be provided in accordance with a later-performed reference operation from the output terminal 300. Here, the reference operation from the output terminal 300 means, for example, an operation of acquiring the support information from the server 20 in accordance with an express operation input of a user in the output terminal 300, such as an access to a web page including the support information via the Internet. Alternatively, in a case where the support information output controlling function 255 determines that certain support information is not to be outputted automatically, that support information may be destroyed and is not necessarily provided to the output terminal 300. For example, in a case where the support information is information that is meaningful only when the information is generated, such a control can be executed by the support information output controlling function 255.

Further, for example, in a case where the information processing system 10 includes the plurality of output terminals 300 held by the inputter and/or the observer, the support information output controlling function 255 may determine the output terminal 300 to which the support information is to be outputted automatically. More specifically, for example, in a case where two or more output terminals 300 are included in the information processing system 10, the two or more output terminals 300 each being held by the inputter (specifically, a person who nurses a toddler, a caregiver who cares an elderly person, or the like) and the observer (a parent of the nursed toddler, a family member of the cared elderly person, or the like, who charges the nursing person or the caregiver with nursing or caregiving), the support information output controlling function 255 may determine whether or not the support information is to be outputted automatically from the output terminal 300 of the inputter or from the output terminal 300 of the observer. It is needless to say that the support information output controlling function 255 may determine that the support information is to be outputted automatically to all the output terminals 300. Further, for example, in a case where the information processing system 10 includes two or more output terminals 300 which are held by the respective plurality of observers (grandparents of the nursed toddler, spouse and children of the cared elderly person), the support information output controlling function 255 may determine one person to whom the support information is to be outputted automatically, from among the plurality of observers (a plurality of users included in the observers) having the output terminal 300.

### (2. Examples of Input of Activity Information)

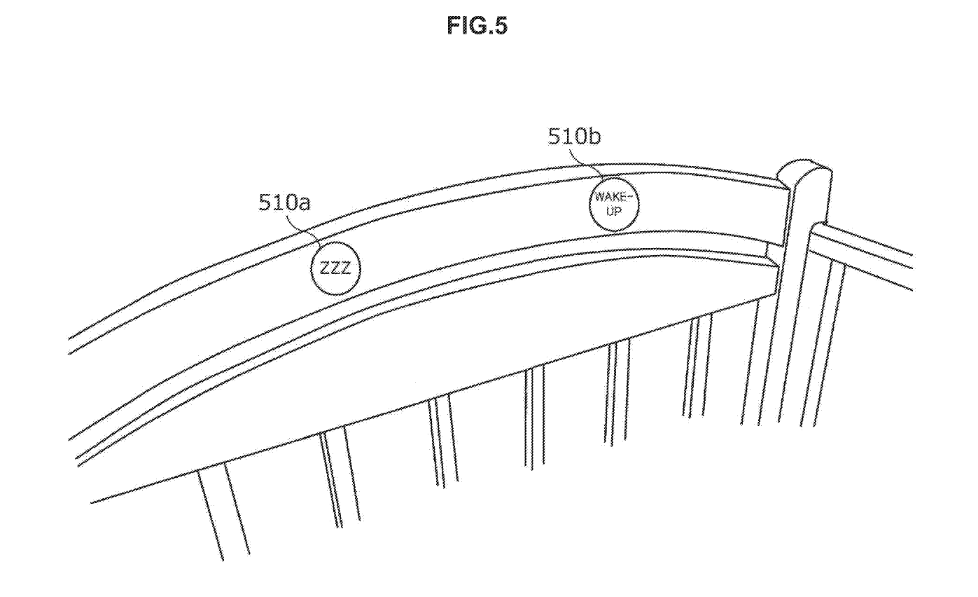

Next, examples of an input of activity information in an embodiment of the present disclosure will be described with reference to FIG. 5.

FIG. 5 shows an example of inputting activity information of the subject by use of an NFC in an embodiment of the present disclosure. Referring to FIG. 5, in a case where the subject is an infant and the input terminal 100 is a smartphone, an NFC reader (not shown) provided for the input terminal 100 communicates with an NFC tag 510 attached to the enclosure of an infant bed, so that activity information related to sleeping or waking of the subject is generated. The input terminal 100 generates the activity information in association with, for example, recognition information of the NFC tag 510 (the recognition information may be information for only recognizing an “NFC tag of an infant bed” or information for recognizing whether an “NFC tag for sleeping” or an “NFC tag for waking”) acquired through communication between the NFC reader and the NFC tag 510, the time when the communication is executed (the time can be used as a time stamp of the activity information), recognition information of the input terminal 100 or the inputter, and the like. The generated activity information can be transmitted to the server 20 automatically.

Here, the NFC tag 510 may be prepared for each kind of activities of the subject, as shown by an NFC tag 510a for sleeping and an NFC tag 510b for waking. In this case, the inputter can generate the activity information indicating “sleeping” or “waking” and complete transmission thereof by only approaching the input terminal 100 to any of the NFC tags 510. Alternatively, only one NFC tag 510 may be attached to the enclosure of the infant bed. In this case, the inputter approaches the input terminal 100 to the NFC tag 510 and then selects “sleeping” or “waking” through a GUI displayed on the input terminal 100 as a result of communication by the NFC reader. The input terminal 100, for example, compensates for recognition information of the NFC tag 510 on the basis of this selection input, generates the activity information indicating “sleeping” or “waking”, and transmits this to the server 20.

The above-described NFC tag 510 may be attached to another tool that is used for an activity of the subject. In a case where the subject is an infant, the NFC 510 may be attached to a feeding bottle, a cushion for nursing, a case of sensitive wipes, and/or a bag for going out. Such an NFC tag 510 can be used to generate the activity information indicating an activity of an infant, such as “milk”, “diaper change”, and “going out”. In generating such activity information, for example, additional information such as “drinking time” or “drunk amount” for “milk”. “kind of excreta” for “diaper change”, or “destination” or “weather” for “going out” may be accepted by an GUI input, for example. Alternatively, as shown by the NFC tags 510a and 510b, the NFC tag 510 corresponding to the additional information may be individually prepared.

In this manner, in a case where the activity information of the subject is inputted by use of the NFC, the inputter can complete the input of the activity information by a simple procedure in which the input terminal 100 is held over the NFC tag 510. Even in a case where additional information is requested to be inputted, since expected kinds of information are already specified, the input can be accepted by a minimum operation by presentation of simple choices, for example. Since the time when the communication is executed can be recorded, the time is not necessarily inputted (modification may be possible). Accordingly, even a busy inputter can more surely acquire the activity information, and the support information generated on the basis of the activity information can be more useful.

Further, in a case where the activity information of the subject is inputted by use of the NFC, without limitation to the smartphone in the above example, various kinds of terminal apparatuses can be used as the input terminal 100. For example, the input terminal 100 may be a wearable terminal having a shape of a bangle or the like. In this case, the inputter can input the activity information with hands free. Further, the input terminal 100 may be a wearable terminal having a shape of a bangle using the NFC and a sensor, for example. In this case, information suitable for acquisition by a sensor can be recorded automatically without use of the NFC. For example, “sleeping time” or “waking time” can be estimated by analyzing information acquired by the sensor and can be recorded automatically.

Note that, as described above, it is possible to generate the activity information of the subject by use of a two-dimensional code instead of or in addition to the NFC. In a case of a two-dimensional code, for example, since a camera module or the like of the input terminal 100 used as a reader is expected to be started, the convenience is not as high as in a case of using the NFC. However, the two-dimensional code can be easily disposed by directly printing the code on a product or by attaching the code as a sticker, and also is disposable. Accordingly, the two-dimensional code can be useful in a case where a large number of tools are used for an activity of the subject or a case where a tool used for an activity of the subject is an expendable to dispose in a short period of time.

Further, it is possible to generate the activity information of the subject on the basis of a text input, a GUI input, or a voice input to the input terminal 100 in addition to or instead of the input using the NFC and/or the two-dimensional code. In this case, since the kind of activity information is unknown at a time when the activity information is input, the inputter is expected to execute more input operations than in a case where the inputter inputs additional information in a case of using the NFC or the two-dimensional code. However, it is possible to set freely the content of the activity information to be generated. Accordingly, for example, in a case where there is an activity in which the subject uses a tool on which the NFC tag or the two-dimensional code is not attached or an activity of a subject who is not associated with a specific tool, generation of the activity information by using the text input, the GUI input, or the voice input can be useful.

### (3. Example of Summary-Type Support Information)

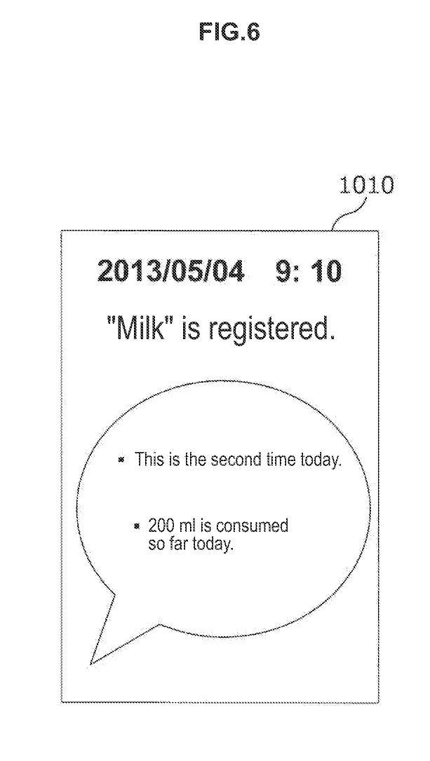

Next, examples of summary-type support information in an embodiment of the present disclosure will be described with reference to FIGS. 6 to 11. In this embodiment, it is possible to provide summary-type support information, as the support information, which is presented by summarizing one or more activities of the subject indicated by activity information. Note that the summary-support information described below can be displayed on a display of the output terminal 300, for example.

FIG. 6 shows a first example of the summary-type support information in an embodiment of the present disclosure. Referring to FIG. 6, in a case where the subject is an infant, support information 1010 which is generated in response to an input of the activity information of “drink milk” is displayed. The support information 1010 may include, in addition to information that reports the occurrence of an activity of “drink milk”, statistical information based on the activity information that has been previously inputted, such as information on frequency, e.g., “This is the second time today”, or information on the total amount, e.g., “200 ml of milk is consumed so far today”, as shown in FIG. 6. Further, in other cases, the support information 1010 may include information on a time interval from the activity information that has been inputted the last time, such as “the milk of the last time was 14:05”, “three and a quarter hours have passed from the diaper change of the last time”, or “awake for four hours”.

Such support information 1010 can be useful for a parent (observer) who charges nursing of an infant to a nanny (inputter) to know activities of the infant that the parent cannot watch directly. In this case, additional information such as the statistical information or information on the time interval may be omitted, and the information that reports the occurrence of an activity may be simply provided as the support information 1010. Alternatively, in a case where the parent (inputter) nurses the infant by himself/herself, the support information 1010 may be provided to the parent (inputter) who has inputted the activity information. In this case, by including additional information such as the statistical information or information on the time interval, the support information 1010 can also be useful to the parent (inputter) himself/herself who has inputted the activity information.

The above-described support information 1010 can be valid when, for example, the support information 1010 is outputted to the output terminal 300 automatically in real time when the activity information from which the support information 1010 is generated is acquired. Accordingly, in a case where the support information generating function 253 generates the support information 1010 in real time, the support information output controlling function 255 of the server 20 may decide that the support information 1010 is outputted automatically from the output terminal 300 in real time. In a case where it is decided that the automatic output is not executed under other conditions described later (e.g. conditions of the observer or the inputter), the support information output controlling function 255 may accumulate the support information 1010 in order to provide the support information 1010 according to reference operations from the output terminal 300 or may destroy the support information 1010.

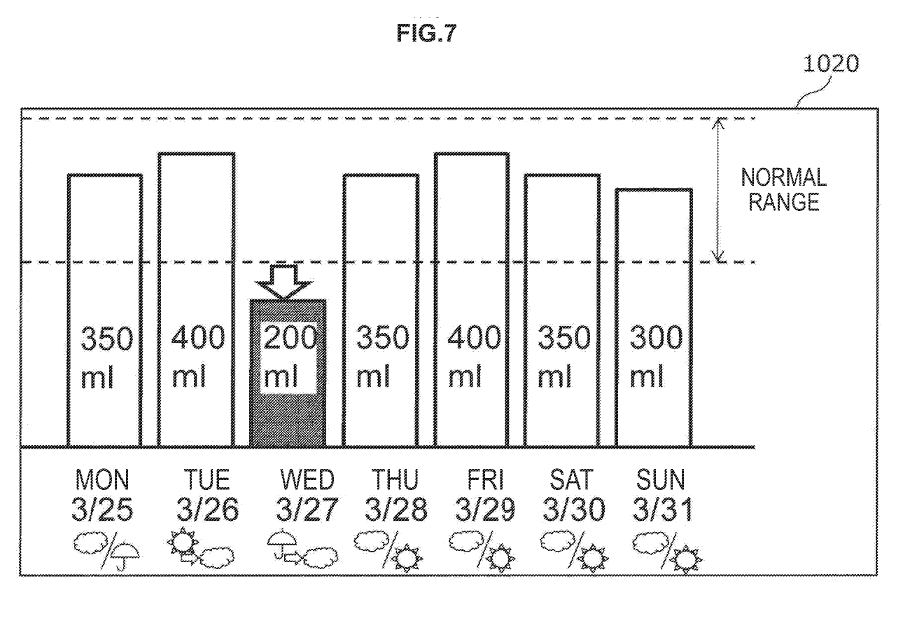

FIG. 7 shows a second example of the summary-type support information in an embodiment of the present disclosure. Referring to FIG. 7, in a case where the subject is an infant, support information 1020 including statistical information related to the activity of “drink milk” of the subject is displayed. The support information 1020 displays a graph of one-week statistics of the amount of milk that the subject drank for each day. Further, the support information generating function 253 of the server 20 may decide a normal range of the amount of milk that the subject drinks a day on the basis of the activity information that has been inputted previously, and in a case where the amount of milk on a specific day is out of the normal range (different from a usual case statistically), the support information generating function 253 may include information indicating this fact, such as “less than usual”, in the support information 1020. Note that the normal range can be decided on the basis of an inter-quartile range of variations in history, for example.

In case where the displayed information indicates a normal state, the above-described support information 1020 is considered to be less necessarily outputted automatically in real time to the output terminal 300 when the activity information from which the support information 1020 is generated is acquired. Accordingly, in a case where the support information 1020 is generated and the amount of milk (content of an activity of the subject) is statistically normal, the support information output controlling function 255 of the server 20 does not necessarily output the support information 1020 automatically in real time to the output terminal 300 and may accumulate the support information 1020 in order to provide the support information 1020 according to reference operations from the output terminal 300. Alternatively, in this case, the support information output controlling function 255 may accumulate the support information 1020 until an automatic output of the support information to the output terminal 300, the automatic output being performed regularly (e.g., once a day) for example. Further alternatively, the support information output controlling function 255 may accumulate the support information 1020 until a timing that is determined appropriate for an automatic output of the support information 1020 under other conditions described later (e.g., conditions of the observer or the inputter), and then output the support information 1020 automatically from the output terminal 300. Note that in a case where information indicated by the support information 1020 is statistically different from a usual case, the support information output controlling function 255 may output the support information 1020 automatically in real time from the output terminal 300.

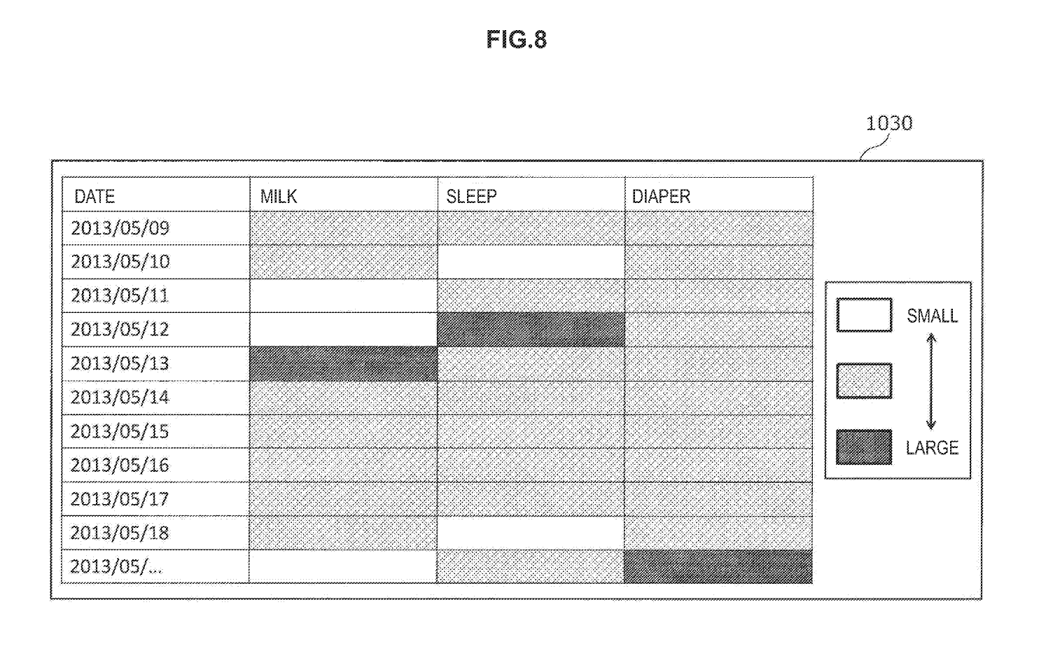

FIG. 8 shows a third example of the summary-type support information in an embodiment of the present disclosure. Referring to FIG. 8, in a case where the subject is an infant, support information 1030 including a graph showing a list of inclinations of a plurality of kinds of activities the subject is displayed. In the support information 1030, the amount and frequency of each activity are shown according to the shade of a displayed color. Specifically, a thin color shows that the frequency and the amount are relatively small, and a thick color shows that the frequency and the amount are relatively large. In the shown example, three level shades of a color display the above information. Similarly to the support information 1020, unless it is indicated that the indicated information is statistically different from a usual case, such support information 1030 does not necessarily outputted to the output terminal 300 automatically in real time, and can be accumulated in order to be provided according to reference operations from the output terminal 300 or can be accumulated until a timing of an automatic output to the output terminal 300, the timing being decided by another factor. Such support information 1030 enables visual recognition of the inclination of an activity indicated by the activity information accumulated in the server 20. Further, relations among inclinations of a plurality of activities can be recognized visually.

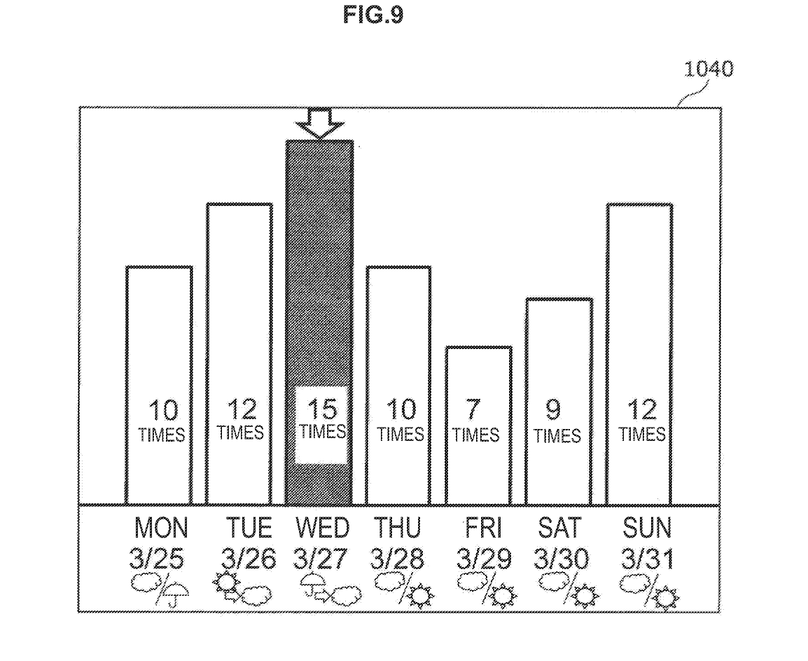

FIG. 9 shows a fourth example of the summary-type support information in an embodiment of the present disclosure. Referring to FIG. 9, in a case where the subject is an infant, support information 1040 including statistical information related to an activity of “diaper change” of the subject is displayed. The support information 1040 displays a graph of one-week statistics of the frequency of diaper change of the subject for each day. Thereby, for example, it is possible to recognize characteristics of the frequency of diaper change of the subject a day according to the day. Such a graph can be displayed even when the history of the activity information includes data for only one week that is displayed, for example. Note that data for a long period of time increases the amount of information. Further, when the activity information is further accumulated, it might be possible to find the relation between the weather of each day and the frequency of diaper change which are displayed, for example. The frequency and amount of milk can be presented similarly. Further, the total sleeping time a day can also be presented similarly.

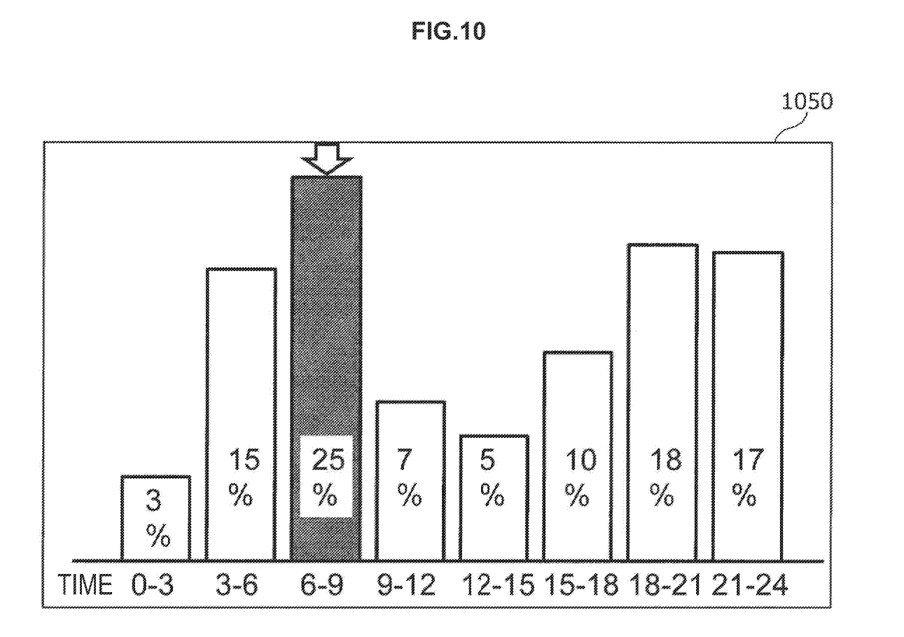

FIG. 10 shows a fifth example of the summary-type support information in an embodiment of the present disclosure. Referring to FIG. 10, in a case where the subject is an infant, support information 1050 including statistical information related to an activity of “diaper change” of the subject is displayed. The support information 1050 displays a graph of the frequency of diaper change of the subject according to a time slot in one day. Such a graph can be displayed when the history of the activity information is accumulated for one day, for example. Note that data for a long period of time increases the amount of information. Display of such a graph as the support information 1050 can make it possible to expect that diapers are changed frequently in six o'clock to nine o'clock in the morning. By providing such information to the inputter who nurses the infant, the inputter can expect more or less his/her action in each time slot. The frequency and amount of milk, the time when the infant wakes up, and the like can also be presented similarly. The time slots set to be displayed as the graph may be divided by three hours as in the shown example or may be divided by one hour or the like.

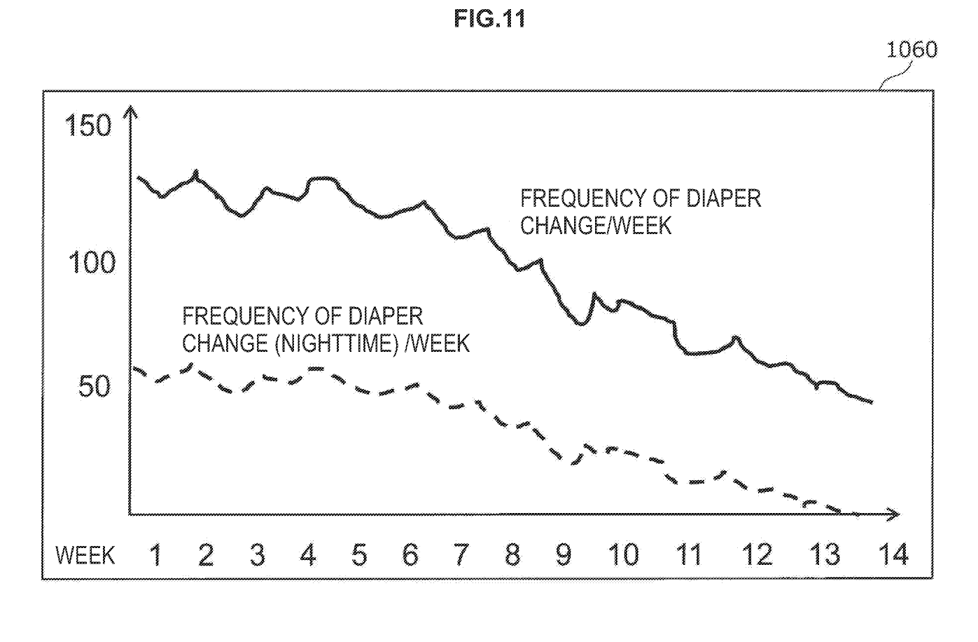

FIG. 11 shows a sixth example of the summary-type support information in an embodiment of the present disclosure. Referring to FIG. 11, in a case where the subject is an infant, support information 1060 including statistical information related to an activity of “diaper change” of the subject is displayed. The support information 1060 displays a graph of the frequency of diaper change of the subject, as a whole and in nighttime separately, according to a week. Such a graph enables visual recognition of a decrease in the frequency of diaper change as the infant grows. The week in which the frequency of diaper change becomes zero (diapers become unnecessary) may be displayed with a certain mark so that the achievement can be realized. Further, for example, since such a graph enables recognition of the frequency of diaper change in a unit of a week, the number of diapers to be carried with when travelling or when going out can be estimated easily.

### (4. Examples of Advice-Type Support Information)

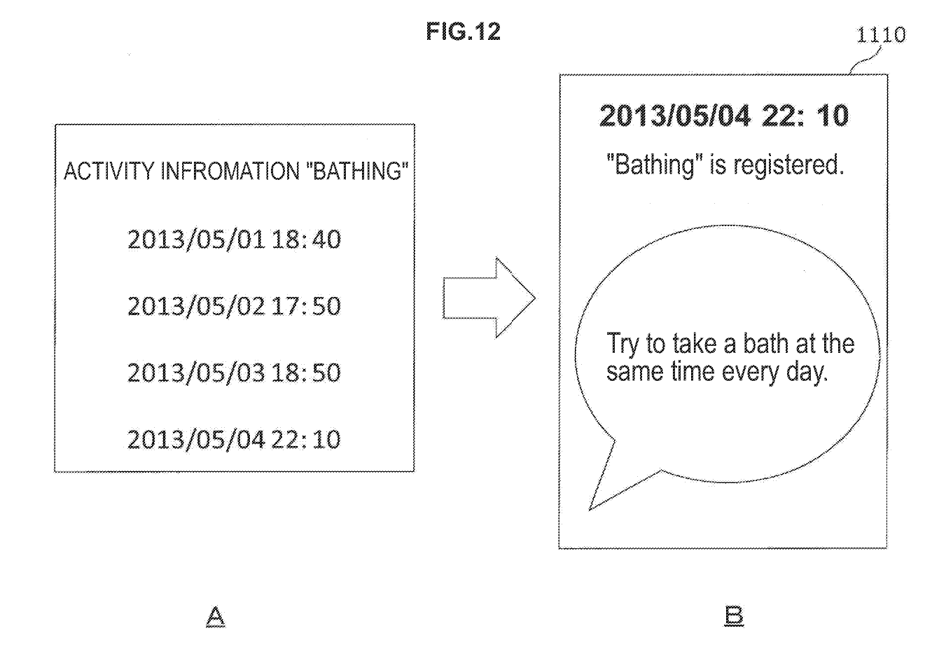

Next, examples of advice-type support information in an embodiment of the present disclosure will be described with reference to FIGS. 12 to 15. In this embodiment, it is possible to provide advice-type support information as the support information, the advice-type support information presenting advice on one or more activities of the subject indicated by activity information. Note that the advice-type support information described below can also be displayed on a display of the output terminal 300, for example.

FIG. 12 shows a first example of the advice-type support information in an embodiment of the present disclosure. Referring to FIG. 12, in a case where the subject is an infant, the activity information of “bathing” is inputted at a time shown in A, and in response, support information 1110 is displayed as shown in B. The support information 1110 includes the advice that “Try to take a bath at the same time every day” in addition to the information reporting the occurrence of the activity of “bathing”. This advice can be generated on the basis of the knowledge that “it is ideal to take a bath at the same time every day in order to adjust the biorhythm of an infant” held in the server 20 as the knowledge information 261, and the fact that the time of the activity information of bathing shown in A is much later than those in the past. In the shown example, although the support information 1110 is displayed by an input of the activity information of bathing because the time is delayed only once, the support information 1110 may be displayed in a case where inputs of the activity information indicating the time delay are repeated predetermined times.

The above-described support information 1110 including advice on the activity of the subject can be valid when being outputted automatically to the output terminal 300 in real time when the activity information (activity information of bathing (of predetermined times) inputted late) from which the support information 1110 is generated is acquired. Accordingly, in a case where the support information generating function 253 generates the support information 1110 in real time, the support information output controlling function 255 of the server 20 may decide to output the support information 1110 automatically from the output terminal 300 in real time. In a case where it is decided that the automatic output is not executed because of other conditions described later (e.g., conditions of the observer or the inputter), the support information output controlling function 255 can accumulate the support information 1110 in order to provide the support information 1110 according to reference operations from the output terminal 300 or can accumulate the support information 1110 until a timing of an automatic output to the output terminal 300 decided by another factor.

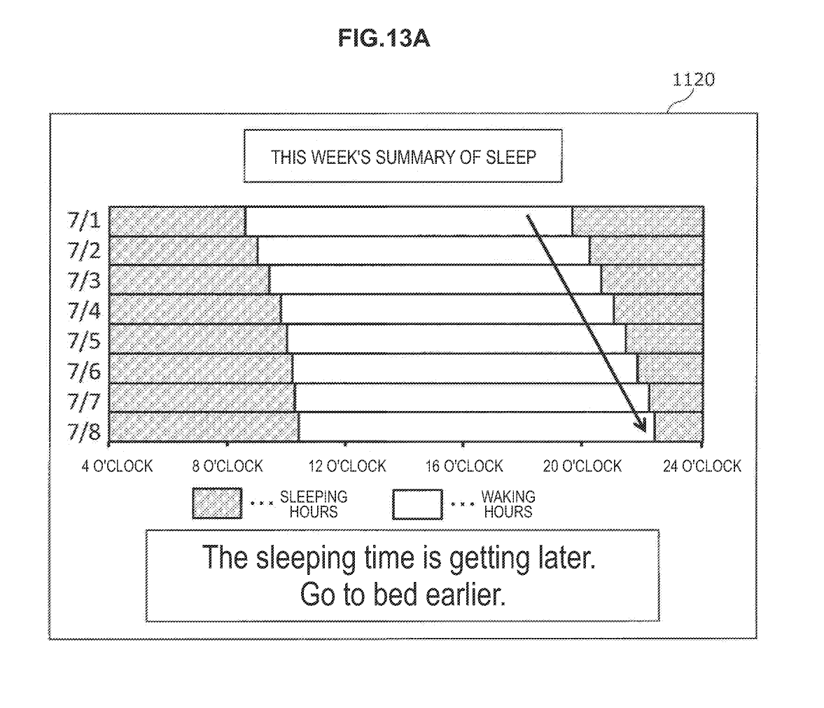

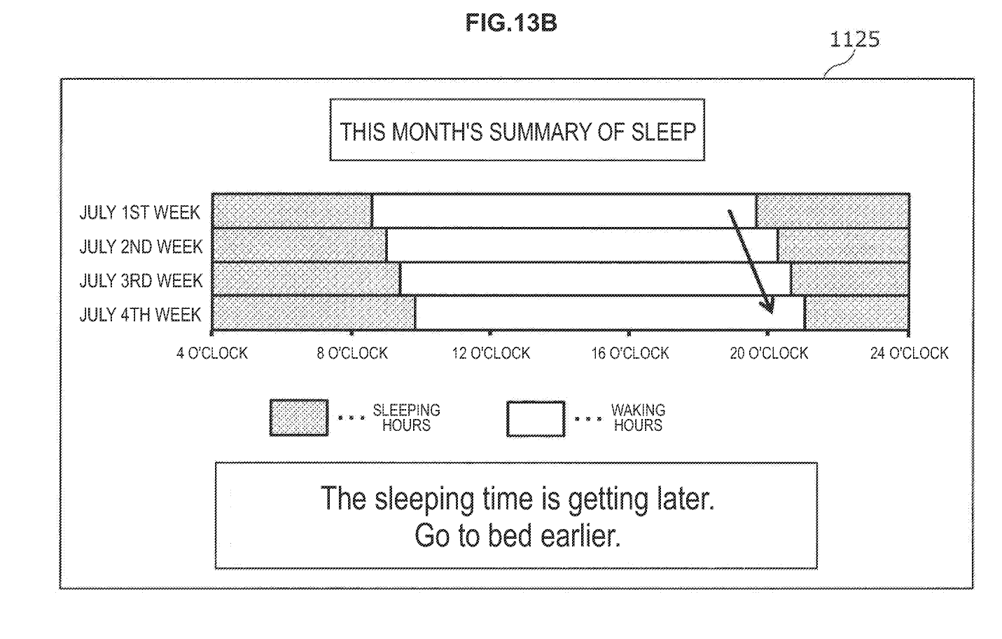

FIGS. 13A and 13B show a second example of the advice-type support information in an embodiment of the present disclosure. Referring to FIG. 13A, in a case where the subject is an infant, support information 1120 including advice generated on the basis of results obtained by accumulating activity information of “sleeping” for one week is displayed. Referring to FIG. 13B, support information 1125 including advice generated on the basis of results obtained by adding up, for each week, results obtained by accumulating the activity information of “sleeping” for one month in a manner similar to that of the above. The support information 1120 and 1125 includes the advice that “The sleeping time is getting later. Go to bed earlier.” in addition to the display of a graph showing conditions of sleep for one week (or one month). This advice can be generated on the basis of both the knowledge that “the sleeping time should not be late” and the activity information indicating that the sleeping time is getting later little by little, which are held in the server 20 as the knowledge information 261.

It might be less necessary that the above-described support information 1120 and 1125 is outputted automatically to the output terminal 300 in real time when activity information (activity information indicating the ease of the subject's sleep on the last day of the week or the month) from which the support information is generated is acquired. Accordingly, in a case where the support information 1120 and 1125 is generated, the support information output controlling function 255 of the server 20 is not necessarily output the support information 1120 and 1125 automatically to the output terminal 300 in real time and may accumulate the support information 1120 and 1125 in order to provide the support information 1120 and 1125 according to reference operations from the output terminal 300. Alternatively, in this case, the support information output controlling function 255 may accumulate the support information 1120 and 1125 until a timing of the automatic output of the support information to the output terminal 300, the automatic output being performed regularly (e.g., one a day). Further alternatively, the support information output controlling function 255 may accumulate the support information 1120 and 1125 until a timing which is determined to be appropriate for the automatic output of the support information by other conditions described later (e.g., conditions of the observer or the inputter) and then automatically output the support information from the output terminal 300.

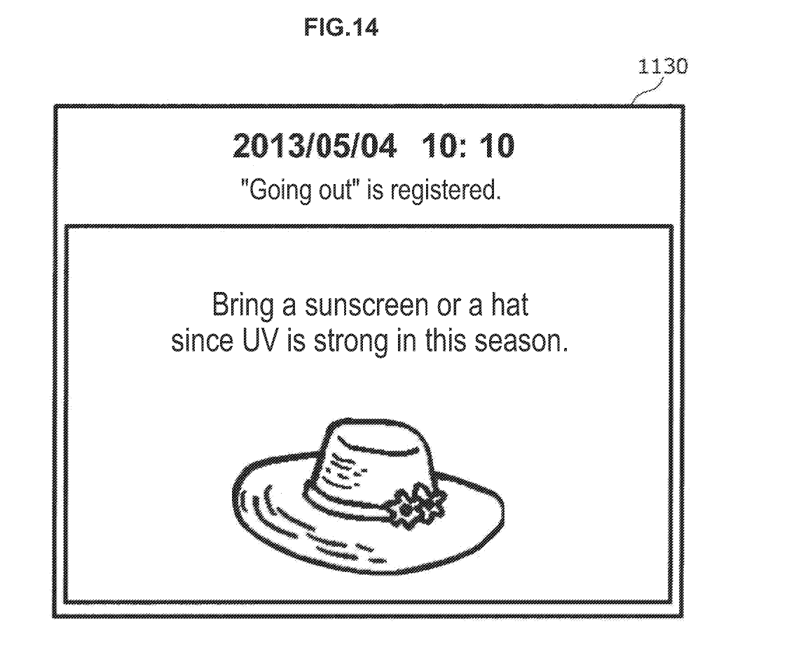

FIG. 14 shows a third example of the advice-type support information in an embodiment of the present disclosure. Referring to FIG. 14, in a case where the subject is an infant, support information 1130 generated in response to an input of activity information of “going out” is displayed. The support information 1130 includes the advice that “Bring a sunscreen or a hat since UV is strong in this season.” in addition to information reporting the occurrence of the activity of “going out”. This advice can be generated on the basis of the knowledge that “a sunscreen or a hat is necessary when the UV is strong”, the intensity of UV on a place of the input terminal 100, which is estimated on the basis of location information of the input terminal 100, and the activity information indicating “going out”, which are held in the server 20 as the knowledge information 261. In this manner, in order to generate the support information, in addition to the information held as the knowledge information 261, other information that can be acquired via a network, such as a weather forecast or UV information, may be used.

The above-described support information 1130 can be valid when being outputted automatically to the output terminal 300 in real time when, for example, activity information (the activity information of going out) from which the support information 1130 is generated is acquired. Accordingly, in a case where the support information 1130 is generated, the support information output controlling function 255 of the server 20 may decide to automatically output the support information 1130 from the output terminal 300 in real time. Since the support information 1130 might become meaningless after the subject goes out or after the subject returns from the going out, in a case where it is decided that the support information is not automatically outputted by other conditions (e.g. conditions of the observer or the inputter) described later, the support information output controlling function 255 may destroy the support information 1130, for example.

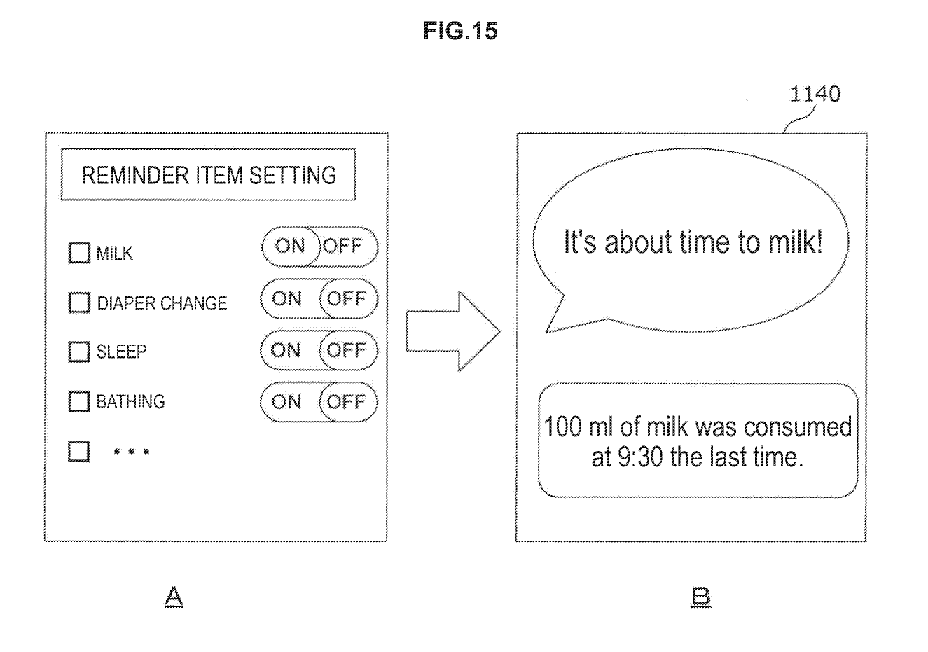

FIG. 15 shows a fourth example of the advice-type support information in an embodiment of the present disclosure. Referring to FIG. 15, in a case where the subject is an infant, support information 1140 including a reminder, as shown in B, regarding a reminder item (milk) set in A is displayed at a predetermined time. The support information 1140 is displayed for the reminder item that is set beforehand and also information based on the activity information of the last time regarding the item (in the shown example, “100 ml of milk was consumed at 9:30 the last time”) is displayed. In this example, the support information output controlling function 255 of the server 20 causes the support information 1140 to be outputted automatically from the output terminal 300 at a timing designated by a user (the inputter or the observer) of the output terminal 300.

In this manner, in this embodiment, the advice-type support information can be provided in various manners. The support information can include various pieces of information without limitation to the above example. For example, the support information may include advice prepared by a specialist such as a pediatrician in a case of an infant. In this case, the name of the specialist may be displayed as the support information, and further, a link to other information (the source of the advice) provided by the specialist may be displayed. The support information can include a link from which the specialist can receive a question (e.g. a link to a message form) so that a direct question to the specialist and a feedback from the specialist can be possible.

In the above example, the support information generating function 253 may determine statistically whether or not an activity seems abnormal from the activity information of the subject and ask a specialist for some advice on the basis of the results. For example, in a case where the time when the activity information of “sleep” at night is input is after 21:30 more than five times a week or where the starting time of a nap in the afternoon is after 15:00 more than five times a week, it may be determined that the activity of “sleep” includes abnormality and provide some advice from a specialist as the support information.

### (5. Examples of Sharing Support Information)

As described above, in the information processing system 10 according to this embodiment, the support information generated in the server 20 on the basis of the activity information of the subject, the activity information being generated in the input terminal 100, is outputted from the output terminal 300. Here, the input terminal 100 is held by the inputter who actually executes or helps the activity of the subject and executes an operation for generating the activity information according to the results. Meanwhile, the output terminal 300 may be held by the inputter in the same manner as the input terminal 100 (in this case, the input terminal 100 can the output terminal 300 can be achieved by the same terminal apparatus) or by the observer who is different from the inputter and the subject. Further, the observer may include a single observer or a plurality of observers.

That is, in the information processing system 10, the generated support information can be shared between the inputter and the observer or between different observers. Some examples of sharing the support information in such a manner will be shown below.

### (Data Sharing for Advice)

For example, a case will be considered in which a guardian who nurses an infant inputs activity information as the inputter in the information processing system 10 and receives support information generated on the basis of the activity information. In this case, the guardian may be a sole receiver of the support information in the completed information processing system 10. However, for example, in a case where the infant is the first child and the guardian is not accustomed to nursing, he or she will have difficulty in stopping the infant's cry at night. In such a case, he or she provides support information (information indicating the infant's life) generated from activity information accumulated in the server 20 to a person who is near the guardian and has experienced nursing, such as a grandmother of the infant (in this case, the grandmother becomes the observer temporarily). By sharing the infant's life as the support information, the person can give more exact advice. Here, in order to obtain the advice, an issue regarding what kind of information to be shared as the support information is valid can be improved gradually by learning for each case (e.g., crying at night, refusing milk, or no change in facial expression), for example.

(Data Sharing in a Case where the Guardians Take Turns)

As another example, a case where both parents nurse an infant will be considered. In this case, activity information is inputted by a parent who is in charge of nursing at that time. Therefore, the inputter takes turns at any time in the information processing system 10. In this case, one of the parents (a father, for example) does not have information during the time when he is not in charge of nursing (i.e., during the time when a mother is in charge of nursing) regarding what kind of life the child had, how high the fever was when the child is sick for example, and the state of excreta. Accordingly, the information processing system 10 can set a parent who is not in charge of nursing as the observer, and can provide support information based on activity information in real time or later. Thus, for example, in a case where the father takes over the child from the mother to take the child to a hospital, he can reply to questions from the doctor appropriately by referring to the support information.

(Data Sharing in a Case where Nursing is Charged)

As another example, a case where the parents charge a nursery with nursing of the infant in daytime will be considered. In this case, activity information is inputted by a staff at the nursery in daytime. Here, if support information generated on the basis of the activity information inputted by the staff at the nursery as the inputter is shared with the parents who are the observers, the parents at office can know the state of the child, for example. Further, it is possible to share the support information with other observers such as grandparents. In this case, the support information output controlling function 255 may select sharing observers according to the content of the support information. For example, the support information output controlling function 255 may decide to share urgent support information, such as one indicating an injury or a sudden high fever, with all the observers including the parents and the grandparents, and may output automatically the support information to the output terminals 300 of all the observers, for example. The support information output controlling function 255 may decide to share other support information with limited members of the observers, such as the parents.

### (6. Examples of Output Control of Support Information)

Although some examples of the output control of support information in this embodiment are described above, more examples of the output control of the support information in this embodiment will be described below.

| | | | | | |
|---|---|---|---|---|---|
| Output | Mother | Father | Grandparents | Nanny | Inputter |
| destination | (main | (observer | (observer 2) | (temporary | when |
| | inputter) | 1) | | inputter) | going |
| | | | | | out |
| Output | unengaged | urgent | first time | before | prepare |
| conditions | external | (report | * can be set | start of | for |
| | infor- | content | by parents | nursing | going |
| | mation | too) | | charge | out |
| | | first time | | from start | |
| | | (report | | to end of | |
| | | only) | | nursing | |
| | | | | charge | |
| Content | various | urgent | first time | * can be set | weather |
| | | first time | * can be set | by parents | forecast |
| | | | by parents | | |

Examples of Output Control of Support Information

In the above example, the subject is an infant and the mother is mainly in charge of nursing. The father is mainly working and rarely in charge of nursing alone. The grandparents are living apart from the parents. The nanny is sometimes asked by the mother to nurse the infant.

In such an example, to the output terminal 300 held by the mother, who is the main inputter, support information is automatically outputted in a case where the mother is estimated to be unengaged, for example. For example, the support information output controlling function 255 of the server 20 may estimate that the mother is unengaged after “the infant falls asleep” is indicated by activity information generated in the input terminal 100 (can be the same terminal apparatus as the output terminal 300) owned by the mother. Further, for example, the support information output controlling function 255 may estimate that the mother is unengaged in a case where the mother does not operate the input terminal 100 for a while (the case may be a case where operations other than an input operation of activity information are not performed). Furthermore, the support information output controlling function 255 may estimate that the mother is unengaged on the basis of results obtained by analyzing activity information indicating an activity of the mother by a technique of human behavior recognition for example, the activity information being acquired by a sensor module of the output terminal 300 (can be the same terminal apparatus as the input terminal 100).

Further, to the output terminal 300 held by the mother, support information may be outputted automatically in a case where a report of the support information is determined to be necessary by external information. For example, in a case where a notification of vaccination arrives from a public organization, when activity information indicates that the child is in good health (e.g. indexes of sleep and the like are kept in normal ranges for a few days), support information which recommends vaccination may be outputted automatically to the output terminal 300 held by the mother. Further, in a case where a notification of an event related to the child, support information can also be outputted automatically. For example, as for a recommended event on the basis of accumulated activity information (in a case where the rhythm of sleep is lost and a seminar of sleep of infants will be held), support information may be outputted automatically preferentially.

In the above example, to the mother's output terminal 300, various pieces of support information such as the above-described examples can be outputted automatically, for example. For example, to the mother's output terminal 300, support information to think back a day, support information including some advice, and the like may be outputted automatically.

On the other hand, in the above example, to the output terminal 300 held by the father, who is the observer near the subject, in a case where the support information is urgent, the support information is outputted automatically. Examples of the case of urgency include an injury, a sudden high fever, and the like. Although the father is mainly at work, he can rush to the child and the mother in a case of urgency. Accordingly, the automatic output of support information at the above timing can be useful. Further, to the output terminal 300 held by the father, support information indicating something that the child did for the first time may be outputted automatically. Note that in a case of the support information indicating something that the child did for the first time, unlike in a case of the urgent support information, a report thereof may be outputted automatically and when the father wants to see the content, the content can be referred by a reference operation.

In the above example, to the output terminal 300 held by the grandparents, who are observers apart from the subject, support information indicating that the infant did something for the first time may be outputted automatically. Unlike in the case of the father, the urgent support information is not necessarily outputted automatically to the output terminal 300 of the grandparents. This is because the grandparents are living apart from the parents as described above, so that it is difficult for them to rush to the infant even when it is urgent (therefore, in a case where the grandparents are living near the parents, the urgent support information may be outputted automatically to the grandparents too). In the shown example, although support information indicating that the infant did something for the first time is outputted automatically to the output terminal 300 of the grandparents is shown, the content of support information to be outputted automatically can be set freely by the parents, for example.

Further, in the above example, to the output terminal 300 held by the nanny, who is the temporary inputter, support information limitedly before the start of nurse charge and from the start to the end of nurse charge. In this manner, the support information output controlling function 255 of the server 20 may determine whether or not support information is outputted automatically to the output terminal 300 of a certain user on the basis of whether or not the user is acting as the inputter. The input of information indicating whether or not the user is acting as the inputter can be executed in the same manner as the input of activity information, at the time of the start and the end of nurse charge, by use of a corresponding NFC tag or a corresponding two-dimensional code. Further, the kinds of support information to be outputted automatically to the output terminal 300 held by the nanny may also be set freely by the parents, for example.

In the above example, to the output terminal 300 held by the inputter when going out (e.g. the mother or the nanny), support information can be outputted automatically at a time of preparation for going out. The time of preparation for going out can be determined on the basis of activity information inputted by use of an NFC tag or a two-dimensional code showing going out, for example. Here, the NFC tag or the two-dimensional code showing going out can be disposed on a tool used for preparation for going out (e.g., a canteen, a hat, a bag carrying diapers, or a stroller). As described above, for example, in a case where the time of preparation for going out is determined on the basis of activity information, for example, weather forecast, UV information, or the like can be outputted automatically to the output terminal 300 as support information.

### (7. Supplement)

Although cases where the subject is an infant is mainly described as examples in the embodiments described above, the application range of a technique according to the present disclosure is not limited thereto, and for example, the technique according to the present disclosure can be applied to various cases in which the subject, the inputter, and/or the observer can be defined, such as a case of caring an elderly person as the subject or a case of independence support for a handicapped person as the subject.

The embodiments of the present disclosure can include, for example, the above-described information processing apparatus, information processing system, information processing method executed in the information processing apparatus or system, program for causing the information processing apparatus to function, non-transitory material medium having the program recorded thereon.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus including a processor which executes:

a function of acquiring activity information indicating at least an activity of a subject, the activity information being inputted by an inputter;

a function of generating support information supporting the activity of the subject on the basis of the activity information; and

a function of controlling an output of the support information to the inputter or an observer who is different from the subject and the inputter on the basis of the support information or the activity information.

(2) The information processing apparatus according to (1), wherein the function of controlling the output of the support information outputs automatically the support information to the inputter or the observer according to content of the support information or the activity information.
(3) The information processing apparatus according to (2), wherein the function of controlling the output of the support information outputs automatically the support information to the inputter or the observer in a case where the support information includes advice for the activity of the subject.
(4) The information processing apparatus according to (3), wherein the function of generating the support information generates the support information including the advice for the activity of the subject on the basis of knowledge information regarding the activity of the subject.
(5) The information processing apparatus according to any one of (2) to (4), wherein the function of controlling the output of the support information outputs automatically the support information to the inputter or the observer in a case where the support information or the activity information indicates that the activity of the subject is statistically different from a normal activity.
(6) The information processing apparatus according to (5),

wherein the observer includes a plurality of users, and

wherein the function of controlling the output of the support information determines one of the plurality of users to whom the support information is to be automatically outputted according to the content of the support information or the activity information.

(7) The information processing apparatus according to (2), wherein the function of controlling the output of the support information outputs automatically the support information to the inputter or the observer in a case where the inputter or the observer is estimated to be unengaged on the basis of the activity information.
(8) The information processing apparatus according to (7),

wherein the function of acquiring the activity information acquires the activity information further indicating an activity of the inputter or the observer, and

wherein the function of controlling the output of the support information estimates whether the inputter or the observer is unengaged on the basis of the activity information indicating the activity of the inputter or the observer.
(9) The information processing apparatus according to (8), wherein the activity information indicating the activity of the inputter or the observer includes information acquired automatically by a sensor.
(10) The information processing apparatus according to any one of (2) to (9),

wherein the function of generating the support information generates the support information in real time when the activity information is acquired, and

wherein the function of controlling the output of the support information determines whether the support information is automatically outputted to the inputter or the observer in real time when the support information is generated.

(11) The information processing apparatus according to (10), wherein the function of controlling the output of the support information accumulates the support information in order to output automatically the support information later to the inputter or the observer in a case where the function of controlling the output of the support information does not output automatically the support information to the inputter or the observer in real time.
(12) The information processing apparatus according to (10), wherein the function of controlling the output of the support information accumulates the support information in order to provide the support information according to a reference operation made by the inputter or the observer in a case where the function of controlling the output of the support information does not output automatically the support information to the inputter or the observer in real time.
(13) The information processing apparatus according to (10), wherein the function of controlling the output of the support information destroys the support information in a case where the function of controlling the output of the support information does not output automatically the support information to the inputter or the observer in real time.
(14) The information processing apparatus according to any one of (1) to (13), wherein the activity information is generated by communication between an NFC tag disposed on a tool used for the activity of the subject and an NFC reader provided in a terminal apparatus held or worn by the inputter.
(15) The information processing apparatus according to any one of (1) to (14), wherein the activity information is generated by reading of a two-dimensional code disposed on a tool used for the activity of the subject, the reading performed by a reader provided in a terminal apparatus held or worn by the inputter.
(16) An information processing method performed by a processor of a computer, the information processing method including:

acquiring activity information indicating at least an activity of a subject, the activity information being inputted by an inputter;

generating support information supporting the activity of the subject on the basis of the activity information; and

controlling an output of the support information to the inputter or an observer who is different from the subject and the inputter on the basis of the support information or the activity information.

(17) A program for causing a processor of a computer to execute:

a function of acquiring activity information indicating at least an activity of a subject, the activity information being inputted by an inputter;

a function of generating support information supporting the activity of the subject on the basis of the activity information; and

a function of controlling an output of the support information to the inputter or an observer who is different from the subject and the inputter on the basis of the support information or the activity information.

(18) An information processing system including one or more information processing apparatuses which execute:

a function of generating activity information indicating an activity of a subject according to an input operation made by an inputter,

a function of generating support information supporting the activity of the subject on the basis of the activity information;

a function of controlling an output of the support information to the inputter or an observer who is different from the subject and the inputter on the basis of the support information or the activity information; and

a function of outputting the support information to the inputter or the observer.

What is claimed is:

1. An information processing apparatus comprising a processor which executes:
a function of acquiring activity information indicating at least an activity of a subject, the activity information being inputted by an inputter;
a function of generating support information supporting the activity of the subject on the basis of the activity information; and
a function of controlling an output of the support information to the inputter or an observer who is different from the subject and the inputter on the basis of the support information or the activity information.

2. The information processing apparatus according to claim 1, wherein the function of controlling the output of the support information outputs automatically the support information to the inputter or the observer according to content of the support information or the activity information.

3. The information processing apparatus according to claim 2, wherein the function of controlling the output of the support information outputs automatically the support information to the inputter or the observer in a case where the support information includes advice for the activity of the subject.

4. The information processing apparatus according to claim 3, wherein the function of generating the support information generates the support information including the advice for the activity of the subject on the basis of knowledge information regarding the activity of the subject.

5. The information processing apparatus according to claim 2, wherein the function of controlling the output of the support information outputs automatically the support information to the inputter or the observer in a case where the support information or the activity information indicates that the activity of the subject is statistically different from a normal activity.

6. The information processing apparatus according to claim 5,
wherein the observer includes a plurality of users, and
wherein the function of controlling the output of the support information determines one of the plurality of users to whom the support information is to be automatically outputted according to the content of the support information or the activity information.

7. The information processing apparatus according to claim 2, wherein the function of controlling the output of the support information outputs automatically the support information to the inputter or the observer in a case where the inputter or the observer is estimated to be unengaged on the basis of the activity information.

8. The information processing apparatus according to claim 7,
wherein the function of acquiring the activity information acquires the activity information further indicating an activity of the inputter or the observer, and
wherein the function of controlling the output of the support information estimates whether the inputter or the observer is unengaged on the basis of the activity information indicating the activity of the inputter or the observer.

9. The information processing apparatus according to claim 8, wherein the activity information indicating the activity of the inputter or the observer includes information acquired automatically by a sensor.

10. The information processing apparatus according to claim 2,
wherein the function of generating the support information generates the support information in real time when the activity information is acquired, and
wherein the function of controlling the output of the support information determines whether the support information is automatically outputted to the inputter or the observer in real time when the support information is generated.

11. The information processing apparatus according to claim 10, wherein the function of controlling the output of the support information accumulates the support information in order to output automatically the support information later to the inputter or the observer in a case where the function of controlling the output of the support information does not output automatically the support information to the inputter or the observer in real time.

12. The information processing apparatus according to claim 10, wherein the function of controlling the output of the support information accumulates the support information in order to provide the support information according to a reference operation made by the inputter or the observer in a case where the function of controlling the output of the support information does not output automatically the support information to the inputter or the observer in real time.

13. The information processing apparatus according to claim 10, wherein the function of controlling the output of the support information destroys the support information in a case where the function of controlling the output of the support information does not output automatically the support information to the inputter or the observer in real time.

14. The information processing apparatus according to claim 1, wherein the activity information is generated by communication between an NFC tag disposed on a tool used for the activity of the subject and an NFC reader provided in a terminal apparatus held or worn by the inputter.

15. The information processing apparatus according to claim 1, wherein the activity information is generated by reading of a two-dimensional code disposed on a tool used for the activity of the subject, the reading performed by a reader provided in a terminal apparatus held or worn by the inputter.

16. An information processing method performed by a processor of a computer, the information processing method comprising:
acquiring activity information indicating at least an activity of a subject, the activity information being inputted by an inputter,
generating support information supporting the activity of the subject on the basis of the activity information; and
controlling an output of the support information to the inputter or an observer who is different from the subject and the inputter on the basis of the support information or the activity information.

17. A program for causing a processor of a computer to execute:
a function of acquiring activity information indicating at least an activity of a subject, the activity information being inputted by an inputter;
a function of generating support information supporting the activity of the subject on the basis of the activity information; and
a function of controlling an output of the support information to the inputter or an observer who is different from the subject and the inputter on the basis of the support information or the activity information.

18. An information processing system comprising one or more information processing apparatuses which execute:
a function of generating activity information indicating an activity of a subject according to an input operation made by an inputter,
a function of generating support information supporting the activity of the subject on the basis of the activity information;
a function of controlling an output of the support information to the inputter or an observer who is different from the subject and the inputter on the basis of the support information or the activity information; and
a function of outputting the support information to the inputter or the observer.
